(19) United States
(12) Patent Application Publication
(10) Pub. No.: US 2006/0238952 A1
(43) Pub. Date: Oct. 26, 2006

(54) Corona discharge apparatus

(75) Inventors: Jung-Tang Huang, Taipei City (TW); Chao-Heng Chien, Taipei City (TW); Fu-Sheng Huang, Fongyuan City (TW)

Correspondence Address: BACON & THOMAS, PLLC, 625 SLATERS LANE, FOURTH FLOOR, ALEXANDRIA, VA, 22314, US

(73) Assignees: Kuender Co., Ltd., Taipei City (TW); Lenghways Technology Co., Ltd., Taipei City (TW); Tatung Co., Ltd., Taipei City (TW)

(21) Appl. No.: 11/111,748

(22) Filed: Apr. 22, 2005

(51) Int. Cl. H02H 1/00

(52) U.S. Cl. 361/212

(57) ABSTRACT

This invention disclosed a corona discharge apparatus composed of a plurality of substrate deposited with matrix of carbon nanotubes. By using ventilation device, the airflow can pass through the corona discharge apparatus, and the electric charge produced due to the corona discharge on the carbon nanotubes. The electric charge impacts oxygen molecular is divided two oxygen atoms. The reaction of oxygen molecular and oxygen atom can produce ozone. Furthermore, by performing corona discharge, at least part of the particle of gas will become charged particle, and the present invention further comprises a particle collector used to collect the charged particle. When the particle in the air followed by airflow pass through the corona discharge apparatus, the electric charge produced due to corona discharge on the carbon nanotubes can attach to the particle to achieve the charging.

### BACKGROUND OF THE INVENTION

1. Field of the Invention

This prevent invention relates to the corona discharge apparatus and more particularly, to the corona discharge apparatus for generating ozone and charged particle, especially negative ion.

2. Description of Related Art

Ozone is formed by the action of sunlight, ultraviolet light or sparks in the air of the thunder on oxygen of the air. It is also formed when electrical apparatus for industrial use generates spark in the air. In recent years, in order to generate ozone, ozone generator often uses high AC voltage to execute electric discharge on the tip discharger for generating corona discharge on the tip electrode. Due to the electric discharge, oxygen molecular will be divided two oxygen atoms, and the reaction of oxygen molecular and oxygen atom can produced ozone. However, there is a limitation on the amount of tip electrode. Due to limited tip electrode of an ozone generator, the user of ozone generator must promote the voltage to generate corona discharge.

Normally, ozone will not suit for existing in the heating environment. Unfortunately, high AC voltage will decrease the amount of ozone because high voltage will cause temperature higher. Therefore, the user of the ozone generator must have a cooling system to drop the temperature of ozone generate. In this case, the cooling system is a problem. To the manufacturer of ozone generator, it is not an economic way to design a cooling system that fits only one particular model of ozone generator. When developed an ozone generator with cooling system, the manufacturer shall have to invest a lot of money to design one and the user will pay more money to buy it. However, increasing the cost of the ozone generator relatively makes the user confused, not in conformity with the requirement for using.

### SUMMARY OF THE INVENTION

The corona discharge apparatus of this present invention comprises a body, comprising a gas inlet and a gas outlet; a corona discharge chamber, disposed in the body, having an intake corresponding to the gas inlet and an exit corresponding to the gas outlet; a plurality of substrates located in the corona discharge chamber, wherein each substrate is formed with a conductive material, deposited with a matrix of carbon nanotubes, and located in a predetermined distance from each other; a circuit, electrically connected to the substrates, for generating a voltage; and a ventilation device located in the body for driving a gas, wherein the gas with a first substance content flows into the intake from the gas inlet, and passes through the matrixes of carbon nanotubes capable of performing corona discharge, and exits the body through the gas outlet from the exit with a second substance content; wherein the second substance content is substantially different from the first substance content. The said substance is preferable to ozone or charged particle, especially negative ion.

Accordingly, it is an object of the present invention to provide a corona discharge apparatus, by using the ventilation device, the airflow can pass through the corona discharge apparatus, and the electric charge produced due to the corona discharge on the carbon nanotubes. The electric charge impacts oxygen molecular is divided two oxygen atoms. The reaction of oxygen molecular and oxygen atom can produce ozone used to sterilize, deodorize, restrain mould growing, and decompose toxin material.

Besides, by performing corona discharge, at least part of the particle will become charged particle, and the present invention further comprises a particle collector used to collect the charged particle. When the particle in the air followed by airflow pass through the corona discharge apparatus, the electric charge produced due to corona discharge on the carbon nanotubes can attach to the particle to achieve the charging.

### BRIEF DESCRIPTION OF THE DRAWINGS

FIG. 1 is a perspective view of a preferred embodiment according to the present invention.

FIG. 2 is a perspective view of a second preferred embodiment according to the present invention.

### DETAILED DESCRIPTION OF THE PREFERRED EMBODIMENT

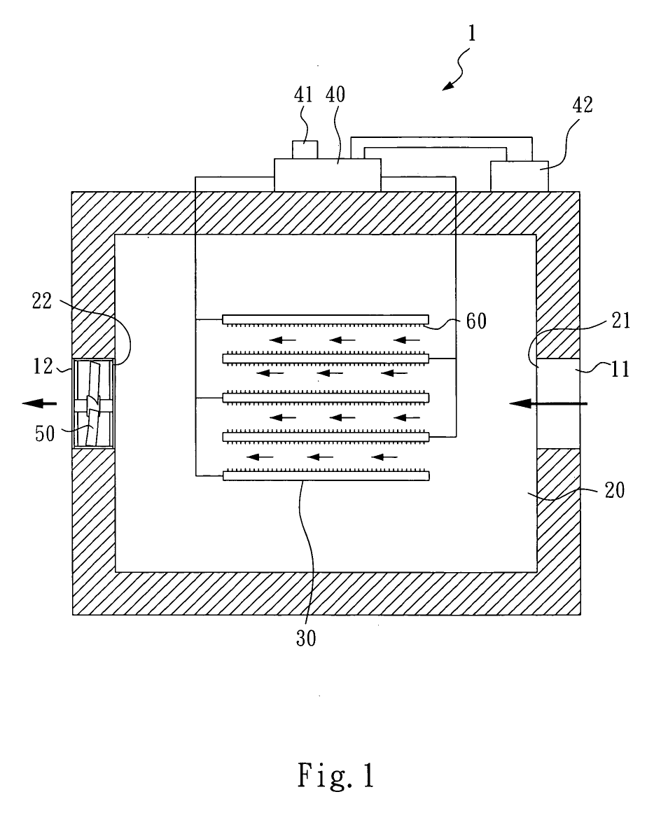

With reference to FIG. 1, there is shown a schematic drawing for a preferred embodiment of the present invention. In this embodiment, a corona discharge apparatus 1 comprises a body 10, a corona discharge chamber 20, a plurality of substrates 30, a circuit 40, and a ventilation device 50. In a preferred embodiment, body 10 comprising a gas inlet 11 and a gas outlet 12; corona discharge chamber 20, disposed in the body 10, having an intake 21 corresponding to the gas inlet 11 and an exit 22 corresponding to the gas outlet 12. In this embodiment, the substrate 30 is preferable to the shape of plate-like which located in the corona discharge chamber 20, but also be other shape such as cylindrical or non-plate shape, wherein each substrate 30 is formed with a conductive material, as a metal, an alloy, or a polymer, deposited with a matrix of carbon nanotubes 60, and located less than 0.5 mm˜1 mm from each other.

As shown in FIG. 1, circuit 40 electrically connected to substrates 30 used to generate a voltage to corona discharge apparatus 1. Therefore, there is a piezoelectric ceramic transformer 42 which connected to circuit 40 and used to elevate voltage to achieve the operation voltage of corona discharged. The voltage is preferably in a range from 500 to 1000V. When circuit 40 generates a voltage to corona discharge apparatus 1, ventilation device 50 will used to drive a gas containing oxygen. Ventilation device 50 is preferably a fan, but may also be device such as vacuum pump. By using fan, the airflow can pass through corona discharge apparatus 1, the gas will flow into the intake 21 from the inlet 11 and pass through the matrixes of carbon nanotubes 60 capable of performing corona discharge and exits body 10 through gas outlet 12 from exit 22. The electric charge produces due to the corona discharge on the carbon nanotubes 60. The electric charge impacts oxygen molecular is divided two oxygen atoms. The reaction of oxygen molecular and oxygen atom can produce ozone. In addition, circuit 40 further comprises a control unit 41 used to control the voltage for regulating the ozone content. In this case, exit 22 has substantially higher ozone content than intake 21.

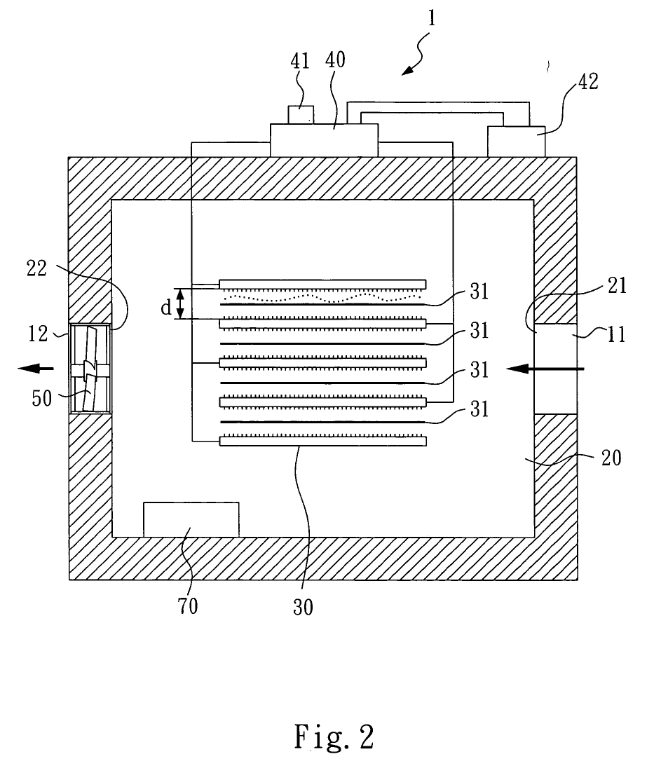

Please refer to the FIG. 2, the gas in the corona discharge apparatus 1 not only has oxygen, but also has some particles. When particles followed by airflow pass through the corona discharge apparatus 1, the electric charge produced due to corona discharge on the carbon nanotubes 60 can attach to the particles to achieve the charging. By performing corona discharge, at least parts of particles become charged particles. Wherein the voltage from the circuit 40 is an AC voltage with a frequency substantially high enough to make the charged particles travel in a trajectory with amplitude of vibration substantially smaller than 0.5 mm. In addition, when the predetermined distance lengthens progressively, the AC voltage will begin to transform into lower gradually. In this embodiment, there is a spacer 31 located between the substrates used to make particle with negative electric charge such as negative ion. Furthermore, corona discharge apparatus 1 comprises a particle collector 70 used to collect the charged particles.

Therefore, the present invention can utilize a matrix of carbon nanotubes 60 to produce corona discharge to generate ozone from gas and can also utilize the carbon nanotubes 60 to make particle of the gas become charged and use a collector 70 to collect the charged particle.

Although the present invention has been explained in relation to its preferred embodiment, it is to be understood that many other possible modifications and variations can be made without departing from the spirit and scope of the invention as hereinafter claimed.

What is claimed is:

1. A corona discharge apparatus, comprising
a body, comprising a gas inlet and a gas outlet;
a corona discharge chamber, disposed in the body, having an intake corresponding to the gas inlet and an exit corresponding to the gas outlet;
a plurality of substrates located in the corona discharge chamber, wherein each substrate is formed with a conductive material, deposited with a matrix of carbon nanotubes, and located in a predetermined distance from each other;
a circuit, electrically connected to the substrates, for generating a voltage; and
a ventilation device located in the body for driving a gas, wherein the gas with a first substance content flows into the intake from the gas inlet, and passes through the matrixes of carbon nanotubes capable of performing corona discharge, and exits the body through the gas outlet from the exit with a second substance content;
wherein the second substance content is substantially different from the first substance content.

2. The corona discharge apparatus of claim 1, wherein each substrate is in the shape of plate-like, cylindrical or non-plate shape.

3. The corona discharge apparatus of claim 1, wherein the conductive material is a metal, an alloy or a conductive polymer.

4. The corona discharge apparatus of claim 1, wherein the substance is ozone and the second substance content is substantially higher than the first substance content.

5. The corona discharge apparatus of claim 4, wherein the gas is oxygen-containing gas.

6. The corona discharge apparatus of claim 4, wherein the circuit comprises a control unit to control the voltage for regulating the second substance content.

7. The corona discharge apparatus of claim 4, wherein the circuit is located inside the body or outside the body.

8. The corona discharge apparatus of claim 4, wherein the ventilation device is a fan or a vacuum pump.

9. The corona discharge apparatus of claim 4, wherein the predetermined distance is less than 0.5 mm.

10. The corona discharge apparatus of claim 4, wherein the circuit comprises a piezoelectric ceramic transformer.

11. The corona discharge apparatus of claim 1, wherein the substance is particles and the second substance content is substantially lower than the first substance content.

12. The corona discharge apparatus of claim 11, wherein at least part of the particles become charged particles caused by performing corona discharge.

13. The corona discharge apparatus of claim 12, further comprising a particle collector to collect the charged particles.

14. The corona discharge apparatus of claim 12, wherein the voltage is an AC voltage with a frequency substantially high enough to make the charged particles travel in a trajectory with an amplitude of vibration substantially smaller than the predetermined distance.

15. The corona discharge apparatus of claim 11, wherein the voltage is in a range from 500V to 1000 V.

16. The corona discharge apparatus of claim 11, wherein at least one spacer is located between the substrates.

17. The corona discharge apparatus of claim 11, wherein the gas is air.
